(19) United States
(12) Patent Application Publication
(10) Pub. No.: US 2004/0040123 A1
(43) Pub. Date: Mar. 4, 2004

(54) Wire stop for multi-strand steel cable

(76) Inventor: Stephan W. Tillitski, Athens, GA (US)

Correspondence Address: GARDNER GROFF, P.C., PAPER MILL VILLAGE, BUILDING 23, 600 VILLAGE TRACE, SUITE 300, MARIETTA, GA, 30067, US

(21) Appl. No.: 10/632,936

(22) Filed: Aug. 1, 2003

Related U.S. Application Data
(60) Provisional application No. 60/407,773, filed on Sep. 3, 2002.
(60) Provisional application No. 60/472,477, filed on May 22, 2003.

(51) Int. Cl. F16G 11/05; F16G 11/06

(52) U.S. Cl. 24/136 L; 24/135 R

(57) ABSTRACT

A wire stop for use with a multi-strand steel cable for securing trees and poles includes an outer body with a tapered opening extending therethrough. The wire stop also includes a tapered inner body with a central bore extending therethrough for receiving a single strand of the multi-strand steel cable therein and is sized and configured to be received in and cooperate with the tapered opening in outer body. With this construction, the multi-strand steel cable can be partially unwound and a single strand threaded through the central bore in the tapered inner body and the remaining strands can be threaded between the inner body and the outer body.

### CROSS-REFERENCE TO RELATED APPLICATIONS

The present application claims priority in the following prior United States Provisional Patent Applications: Serial No. 60/407,773 filed on Sep. 3, 2002; Serial No. ______ filed on ______; and Serial No. 60/472,477 filed on May 22, 2003.

### TECHNICAL FIELD

The present invention relates generally to rigging and in particular relates to a cable attachment for securing steel cable to trees, power poles, and the like.

### BACKGROUND OF THE INVENTION

In the field of rigging, it is often necessary to secure one pole to another or to secure one part of a tree to the remainder the tree or to simply secure a tree against falling over. To provide this kind of structural support, it is known to attach one end of a cable to the tree or pole to be supported and the other end of the cable to another object. However, the mechanics of attaching the cable to a tree or pole can present certain technical difficulties in the field.

In such an application, steel cables, such as multi-strand steel cables, typically have been used and are still used today to support trees, power poles and similar items. Such cables are typically attached to a tree or utility pole by attaching a J-hook or lag bolt that is screwed into the tree or pole. A thimble and a “preformed wrap” is attached to the J-hook. Alternatively, the steel cable can be bent around the J-hook and the thimble then secured with “bulldog clips”. Alternatively, the steel cable is attached using eye bolts installed through the tree or pole and secured in like manner.

The above described attachment techniques suffer from requiring multiple parts to secure the steel cable. Also, because of the multiple parts involved, the collection of the multiple parts is only as strong as the weakest of the parts, which in this case typically tends to be the lag bolts or J-hooks, the preformed wraps, or the bulldog clips. These attachment techniques also tend to be difficult to use in close quarters, such as when the trunks of a tree are closer together than about three feet or so.

Accordingly, it can be seen that a need yet remains in the art for a device for attaching steel cable to trees and poles, which device is strong, easily used in the field, compact, and with few parts. It is to the provision of such a device at the present invention is primarily directed.

### SUMMARY OF THE INVENTION

Briefly described, in a first preferred form the present invention comprises a wire stop for use with a multi-strand steel cable for securing trees and poles. The wire stop includes an outer body with a tapered opening extending therethrough. The wire stop also includes a tapered inner body with a central bore extending therethrough for receiving a single strand of the multi-strand steel cable therein. The tapered inner body is sized and configured to be received in and cooperate with the tapered opening in outer body. With this construction, the multi-strand steel cable can be partially unwound and a single strand threaded through the central bore in the tapered inner body and the remaining strands can be threaded between the inner body and the outer body. Upon the application of a tensile force on the cable, the cable is held fast by the wire stop. Preferably, the tapered inner body is frustoconical in shape. Alternatively, the central bore could be omitted and the central strand of the cable could join the others in the periphery around the tapered inner body.

In another preferred form, the present invention comprises a wire stop for use with a multi-strand steel cable and includes an outer body with a central opening extending therethrough and a plurality of cable engaging wedges. The wedges are sized and adapted to be received in the central opening. The central opening and/or the plurality of cable engaging wedges are tapered so as to clamp the cable engaging wedges tightly to the steel cable when a tensile load is placed on the cable. Preferably, the central opening is tapered and outer surfaces of the plurality of cable engaging wedges are similarly tapered. Also preferably, there are two wedges. Most preferably, the wedges, when considered collectively, are generally frustoconical in shape. Alternatively, an upper collar can be initially secured to the steel cable using a threaded fastener to help secure the wedges within the outer body until a substantial tensile load is placed on the steel cable.

In yet another preferred form of the invention, the invention comprises a wire stop for use with a multi-strand steel cable. The wire stop includes a ferrule having a central bore extending therethrough for receiving a steel cable therein. The ferrule is provided with a plurality of threaded fasteners threaded therein and which extend toward the central bore for securing the steel cable within the ferrule. Preferably, three such threaded fasteners are provided in the form of setscrews. Also preferably, the threaded fasteners are oriented at an oblique angle relative to the central bore to improve the “bite” of the threaded fasteners against the steel cable within the bore.

The present invention allows for a more finished appearance, at low cost, with less clutter. It also is easy to install in the field and provides a very secure attachment of a steel cable to a tree or pole. Also, because of the compactness of the attachment, it can be used in places that heretofore were generally not suitable for the prior art attachment arrangements.

### BRIEF DESCRIPTION OF THE DRAWING FIGURES

FIG. 1 is a side, sectional view of a wire stop according to a first preferred form of the invention, showing strands of a multi-strand steel cable extending therethrough. FIG. 2 is an end view of the wire stop of FIG. 1, showing strands of a multi-strand steel cable extending therethrough. FIG. 3A is an end view of an inner portion of the wire stop of FIG. 1 and FIG. 3B is a side view of that inner portion. FIG. 4A is an end view of an outer portion of the wire stop of FIG. 1 and FIG. 4B is a side view of that outer portion.

FIG. 5 is a side view of a wire stop according to a second preferred form of the invention, showing a multi-strand steel cable extending therethrough. FIG. 6A is side, sectional view of the wire stop of FIG. 5, with an external collar portion thereof omitted. FIG. 6B is an end, sectional, schematic view of a portion of the wire stop of FIG. 5, showing a multi-strand cable (schematically) and a pair of cable-engaging wedge portions of the wire stop.

FIG. 7 is a schematic side view of a wire stop according to a third preferred form of the invention, showing a multi-strand steel cable extending therethrough. FIG. 8 is an end view of the wire stop of FIG. 7. FIG. 9 is a side, sectional view of the wire stop of FIG. 7, showing a perpendicular threaded fastener configuration. FIG. 10 is a side, sectional view of the wire stop of FIG. 7 in a modified or alternative form, showing an angled threaded fastener configuration.

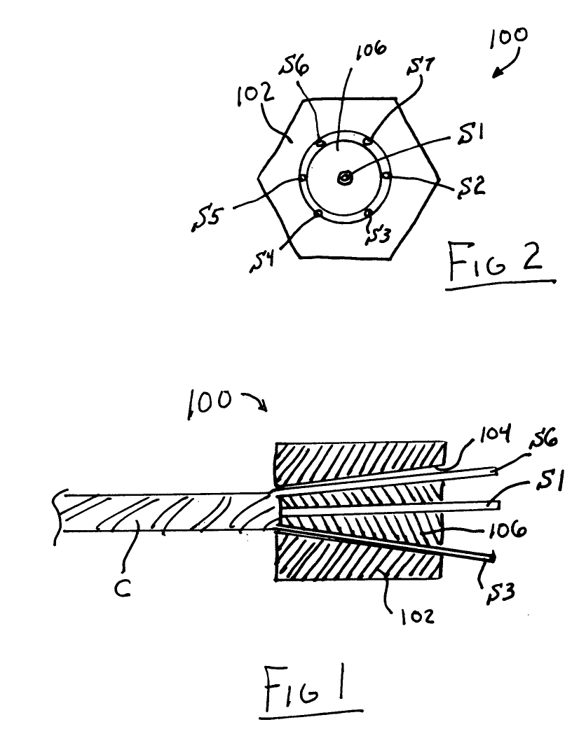

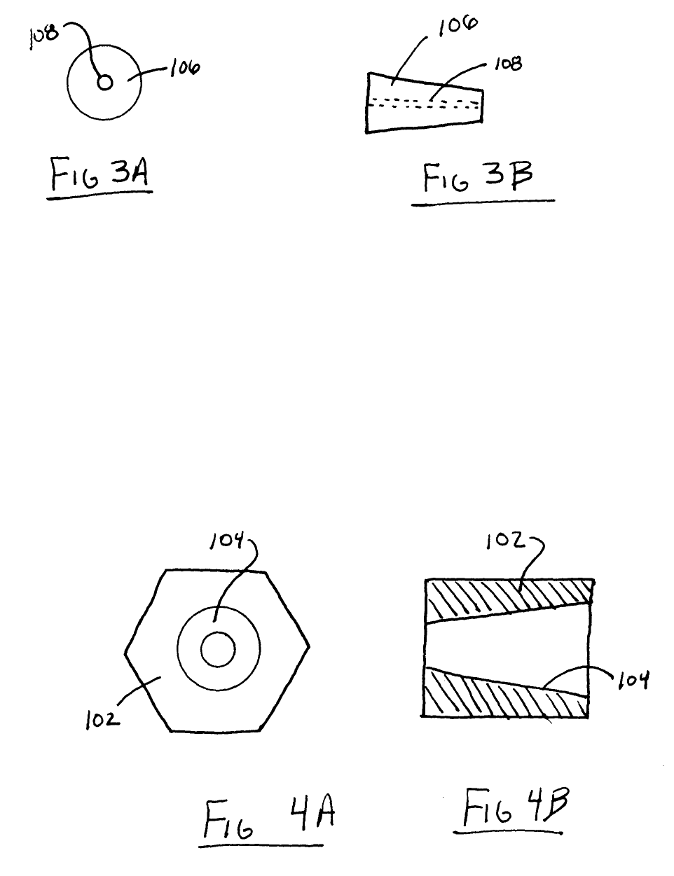

### DETAILED DESCRIPTION OF EXAMPLE EMBODIMENTS

The present invention may be understood more readily by reference to the following detailed description of the invention taken in connection with the accompanying drawing figures, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention. Also, as used in the specification including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment. Moreover, while the invention is described in connection with the use of multi-strand steel cable, it will be recognized that the invention is not limited to such use and that other types of cable, wire, and the like can be used with the present invention.

With reference now to the drawing figures, a wire stop 100 according to a first preferred form of the invention is shown in FIG. 14B. The wire stop 100 includes an outer body 102 defining a tapered opening defined by tapered surface 104 extending therethrough. Although the depicted embodiment has a hexagon shaped outer body 102, those skilled in the art will recognize that other shapes can be employed, such as round, rectangular, etc. Indeed, these alternative shapes are within the scope of the present invention. The shape and the size of the outer body 102 may depend on the intended use of the wire stop 100. In the preferred embodiment illustrated in these figures, the outer body 102 is formed to be secured on the outer portion of the structure being rigged, such as for example a pole or tree. Alternatively, the outer body 102 can be set partially within a counter bore or otherwise inlet into the structure being rigged. Preferably, the outer body 102, and the other parts of the wire stop 100, are made of a corrosion-resistant steel or other suitable material. The applicant has found aluminum to work well for either or both the outer body and the inner body. While steel has high strength, the softer aluminum provides a very good grip while minimizing the tendency to cut or break the strands of the cable. Also, the applicant has found that the use of a steel outer body and an aluminum inner body (or vice versa) works very well also. It is also possible to use brass or other materials for some or all of the wire stop.

The wire stop 100 also includes a tapered inner body 106. The tapered inner body 106 is sized and configured to be received in and cooperate with the tapered opening 104 in the outer body 102. In the depicted embodiment, the inner body 106 has a complementary frustoconical shape to be closely received within the opening 104 of the outer body 102. Alternatively, the cross-sectional shape of the inner body 106 may be triangular, rectangular, or oblong variations of such, so long as the inner body 106 is shaped and/or sized to be substantially receivable within the tapered opening of the outer body 102. It is preferred, but not required, that the inner body 106 includes a central bore 108 extending therethrough for receiving the central strand S1 of the multi-strand steel cable C therein. Alternatively, the central bore 108 can be omitted from the inner body 106.

In using the wire stop 100 to attach a multi-strand steel cable to a tree or pole, the multi-strand steel cable C can be partially unraveled and the individual strands can be threaded into the wire stop 100. Preferably, the central strand S1 is threaded through the central bore 108 in the tapered inner body 106, and the outer strands S2-S7 are slipped between the inner body 106 and the outer body 102. Upon the application of a tensile force on the cable, the strands pull the inner body 106 into the outer body 102, whereby the cable is held fast in a static state by the wire stop 100. Preferably, the outer body 102 and the inner body 106 are fabricated from stainless steel or other high strength metals that are durable and resistant to corrosion. However, it is possible to incorporate other less durable materials for rigging procedures demanding less durability and corrosion resistance, so long as the material will maintain the tensile load applied upon it.

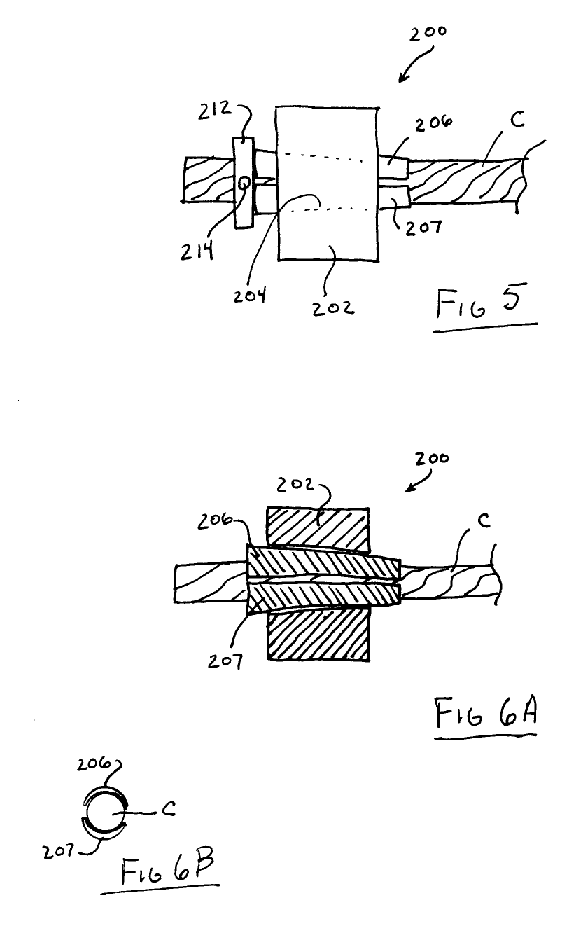

Referring now to FIGS. 5-6B, a wire stop 200 is shown according to another preferred form of the present invention for use with a multi-strand steel cable C. The wire stop 200 includes an outer body 202 with a central opening 204 extending therethrough. Preferably, the opening 204 is formed to be tapered and to have a minimum diameter slightly larger than the cable to be inserted therein. A pair of cable-engaging wedges 206, 207 are sized and shaped to receive a cable extending therein. The wedges 206, 207 are also sized and adapted to be received in the central opening and have an outer taper that corresponds to the inner taper of the central opening 204. Furthermore, the wedge, considered collectively, are generally frustoconical in overall shape and when placed together define an inner aperture extending axially therealong for receiving the cable C therein. For example, the central opening 204 and/or the wedges 206, 207 are tapered so as to clamp the wedges tightly to the cable when a tensile load is placed on the cable. In the depicted embodiment, the central opening 204 is tapered and the outer surfaces of the cable engaging wedges are similarly tapered. Although the depicted embodiment shows two wedges, the incorporation of three or more wedges is within the scope of the present invention. Optionally, the inner surfaces of the wedges 206, 207 can be provided with a slip-resistant surface texture or include protrusions which further prevent slippage of the cable under load. Similar to the embodiment of FIG. 14, the parts of the wire stop 200 can be made from steel, aluminum, brass, or other suitable material.

Referring still to FIG. 5, optionally, an upper collar 212 is provided and can be secured to the cable C as a temporary means of holding the wire stop 200 together and in place. The collar 212 preferably is secured to the cable C by way of a threaded faster 214. The collar 212 secures the wedges within the outer body 202 until a substantial tensile load is placed upon the cable C.

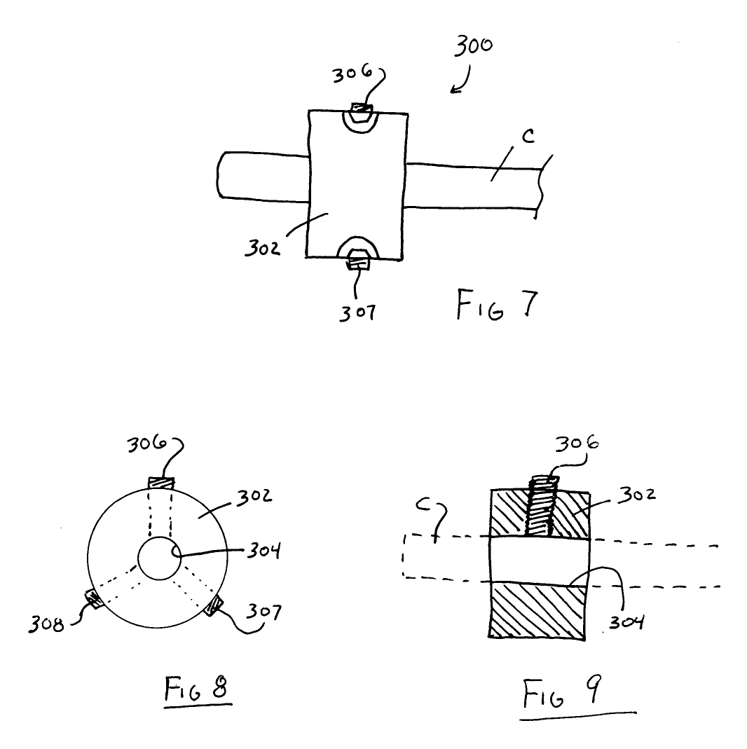

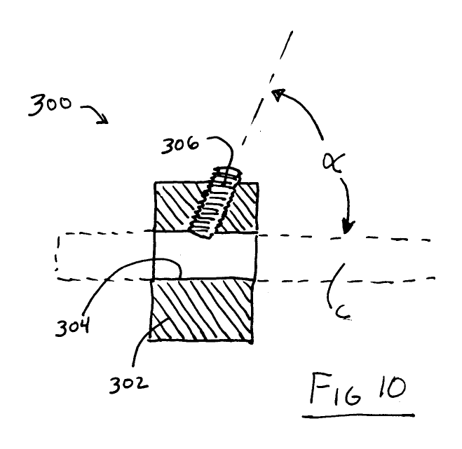

Referring now to FIGS. 7-10, yet another preferred form of the invention is shown, comprising a wire stop 300. The wire stop 300 has cylindrical body or ferrule 302 defining a central bore 304 extending axially therethrough. In the preferred exemplary embodiment depicted, the ferrule 302 is provided with three threaded fasteners 306, 307 and 308 threaded into the ferrule and which extend radially toward the central bore 304 for securing the steel cable C within the ferrule 302. In a preferred embodiment, the fasteners 306, 307 and 308 are positioned to be substantially perpendicular in relation to the bore 304. Similar to the embodiment of FIG. 14, the parts of the wire stop 200 can be made from steel, aluminum, brass, or other suitable material.

Alternatively, as shown in FIG. 10, the fasteners 306, 307 and 308 are oriented at an oblique angle α relative to the central bore, in order to improve the “bite” of the fasteners 306, 307 and 308 against the cable C within the bore 304. Preferably, the angle α is within several degrees of perpendicular so that a little extra grip is placed on the cable without creating too great a tendency to cut the cable with the edge of the fastener. Although three fasteners are preferred and shown in the figures, the inclusion of fewer or greater numbers of fasteners is within the scope of the present invention. Upon insertion of the cable C within the bore 304 of the ferrule 302, the fasteners are tightened to secure the cable within the bore, and the cable is held fast despite a tensile force applied upon it.

While the invention has been described with reference to preferred and exemplary embodiments, it will be understood by those skilled in the art that a variety of modifications, additions and deletions can be made therein without departing from the spirit and scope of the invention, as defined by the following claims.

I claim:

1. A wire stop for use with a multi-strand steel cable, the wire stop comprising:
an outer body with a central opening extending therethrough;
a plurality of cable engaging wedges sized and adapted to be received in the central opening, the central opening and/or the plurality of cable engaging wedges being tapered so as to clamp the wedges tightly to the steel cable when a tensile load is placed on the steel cable.

2. A wire stop as claimed in claim 1 further comprising an external collar to be initially secured to the steel cable by a threaded fastener.

3. A wire stop as claimed in claim 1 wherein the central opening is tapered and outer surfaces of the plurality of cable engaging wedges are tapered.

4. A wire stop as claimed in claim 3 wherein the plurality of cable engaging wedges comprises two such wedges.

5. A wire stop as claimed in claim 3 wherein the plurality of cable engaging wedges collectively have a generally frustoconical shape.

6. A wire stop for use with a multi-strand steel cable, the wire stop comprising:
an outer body with a tapered opening extending therethrough;
a tapered inner body being sized and configured to be received in and cooperate with the tapered opening in the outer body; and
wherein a multi-strand steel cable can be partially unraveled and the individual strands of the steel cable can be threaded between the inner body and the outer body, and wherein upon the application of tensile force on the steel cable, the steel cable can be held fast by the wire stop.

7. A wire stop as claimed in claim 6 wherein the tapered inner body has a central bore extending therethrough for receiving a strand of the multi-strand steel cable therein and wherein a single strand of the steel cable can be threaded through the central bore in the tapered inner body and the remaining strands can be threaded between the inner body and the outer body.

8. A wire stop as claimed in claim 6 wherein the tapered inner body has a frustoconical shape and the tapered opening in the outer body has a similar taper.

9. A wire stop for use with a multi-strand steel cable, the wire stop comprising;
a ferrule having a central bore extending therethrough for receiving a steel cable therein; and
the ferrule having a plurality of threaded fasteners threaded therein and extending toward the central bore for securing the steel cable within the central bore.

10. A wire stop as claimed in claim 9 wherein the plurality of threaded fasteners comprises three threaded fasteners.

11. A wire stop as claimed in claim 9 wherein the plurality of threaded fasteners comprises three setscrews.

12. A wire stop as claimed in claim 9 wherein the threaded fasteners are oriented at an oblique angle relative to the central bore.

13. A wire stop as claimed in claim 9 wherein the threaded fasteners are oriented to be perpendicular to the central bore.
